(19) United States
(12) Patent Application Publication
(10) Pub. No.: US 2026/0254095 A1
(43) Pub. Date: Aug. 27, 2026

(54) HALL THRUSTER STATE MONITORING

(71) Applicant: The Aerospace Corporation, El Segundo, CA (US)

(72) Inventor: Nicolas Augustus RONGIONE, Woodland Hills, CA (US)

(73) Assignee: The Aerospace Corporation, El Segundo, CA (US)

(21) Appl. No.: 19/062,966

(22) Filed: Feb. 25, 2025

(51) Int. Cl. H01Q 1/22; F03H 1/00

(52) U.S. Cl. CPC H01Q 1/22; F03H 1/0037

(57) ABSTRACT

A hall thruster monitoring system includes an antenna placed near or in the vicinity of a thruster. The hall thruster monitoring system also includes a radio frequency (RF) cable connecting the antenna with an oscilloscope or RF digitizer and a computing system to perform the analysis of thruster emissions.

### FIELD

The present invention generally pertains to a monitoring system, and more particularly, to a hall thruster state monitoring system using an omnidirectional antenna.

### BACKGROUND

Currently, there are two ways for performing hall thruster state monitoring. First, in space, hall thruster state monitoring is performed with an onboard telemetry system providing various diagnostics of thruster's health. On the ground, hall thruster state monitoring is performed with dedicated breakout boxes and other techniques, such as high-speed current probes on the anode discharge power harness, to provide the thruster's health. These techniques are useful, but are also different from each other. For example, the method for monitoring in space versus the method for monitoring on the ground varies. Additionally, in space acquisitions are typically lower data rates or down sampled versus ground data, which can be taken with higher data rates and without storage, transmission, or processing limitations.

Accordingly, an improved and/or alternative approach may be beneficial. More specifically, it may be beneficial to use a single device that can be used both on the ground and in space to provide hall thruster state monitoring.

### SUMMARY

Certain embodiments of the present invention may be implemented and provide solutions to the problems and needs in the art that have not yet been fully solved by existing communications technologies. For example, some embodiments pertain to hall thruster state monitoring using an omnidirectional antenna.

In an embodiment, a hall thruster monitoring system includes an antenna placed near or in the vicinity of a thruster. The hall thruster monitoring system also includes a radio frequency (RF) cable connecting the antenna with an oscilloscope to perform the analysis of thruster emissions.

In another embodiment, a hall thruster monitoring system includes an antenna placed near or in the vicinity of a thruster. The hall thruster monitoring system also includes an RF cable connecting the antenna with an oscilloscope to perform the analysis of thruster emissions. In certain embodiments, the antenna is placed in the line of sight of the thruster.

In yet another embodiment, a hall thruster monitoring system includes an antenna placed near or in the vicinity of a thruster. The hall thruster monitoring system also includes an RF cable connecting the antenna with an oscilloscope to perform the analysis of thruster emissions. The hall thruster monitoring system further includes a direct current (DC) block configured to block DC signals in a signal voltage from entering the oscilloscope or RF digitizer to provide scope protection. The DC block is placed directly in front of the oscilloscope or the RF digitizer.

### BRIEF DESCRIPTION OF THE DRAWINGS

In order that the advantages of certain embodiments of the invention will be readily understood, a more particular description of the invention briefly described above will be rendered by reference to specific embodiments that are illustrated in the appended drawings. While it should be understood that these drawings depict only typical embodiments of the invention and are not therefore to be considered to be limiting of its scope, the invention will be described and explained with additional specificity and detail through the use of the accompanying drawings, in which:

FIG. 1 is a diagram illustrating a hall thruster state monitoring system using an omnidirectional antenna, according to an embodiment of the present invention.

FIG. 2 is a graph illustrating a thruster operating mode monitoring conducted emissions (CE) using a current probe in the time and frequency domains, compared to monitoring radiated emissions (RE) using the omnidirectional antenna in time and frequency domains, according to an embodiment of the present invention.

FIG. 3 is a chart showing a comparison between the current probe and antenna breathing mode sensor, according to an embodiment of the present invention.

FIG. 4 is a diagram illustrating a hall thruster state monitoring system using an omnidirectional antenna in space, according to an embodiment of the present invention.

Unless otherwise indicated, similar reference characters denote corresponding features consistently throughout the attached drawings.

### DETAILED DESCRIPTION OF THE EMBODIMENTS

Some embodiments of the present invention pertain to a hall thruster state monitoring system using an omnidirectional antenna. The omnidirectional antenna (hereinafter “antenna”) may provide a more consistent method to track or monitor the hall thruster state and/or characteristics. Other information that may be provided includes, but is not limited to, interference data or frequency data, to name a few, from a hall thruster operating in space. In addition, there is plasma specific or thruster specific information that can be deduced from the emission.

The hall thruster state monitoring system is a multi-purpose device that detects passive emissions from the thruster. It is the analysis of the emissions that are most important. From the analysis, instabilities that relate to the health of the thrust can be distinguished. There also may be the ability to distinguish between the operating modes which are demonstrated in data. The additional benefit offered is having a consistent way of comparing data during flight, and in so doing, a library of data is developed to identify out-of-family performance.

These benefits are important, because manufacturer tolerances are not well known so far that they propagate to variation from part to part in relation to electromagnetic interference (EMI). This monitoring system, which may be integrated into the production cycle, may help identify out of family tolerance with implementation over time. For example, if an electronic emitter (i.e., a cathode) on a hall effect thruster has a particular orifice (with a specific tolerance, under normal inspection/diagnostics), differences in the health of the thruster may not be realized. With the placement of the antenna described herein, which actually picks up both low frequency and gigahertz transmissions, electron dynamics in the changes in the spectra from one thruster to the next are realized. In other words, the changes in tolerance mechanically that are showing up as changes in the spectra. Unlike the current probe, which are typically limited to conducted emissions up to a gigahertz and below, the antenna described herein also offers access to radiated emissions data at a gigahertz and above.

This hall thruster state monitoring system offers the ability to delve into quality control issues, which may be of interest to manufacturers that are interested in part-to-part variation. It may also be of interest to manufacturers that are interested in upscaling the manufacturing of hall thrusters. Manufacturers typically do not know how well the parts can be reproduced, which can be solved by the hall thruster state monitoring system, to provide a consist manufacturing process.

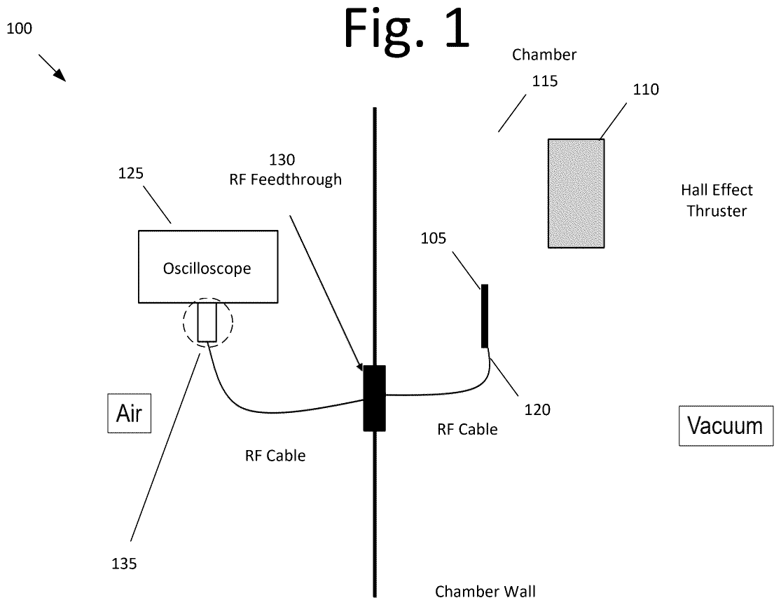

FIG. 1 is a diagram illustrating a hall thruster state monitoring system 100 using an omnidirectional antenna (the “antenna”) 105, according to an embodiment of the present invention. Antenna 105 may be used in an ambient environment or in a vacuum environment. In some embodiments, thruster 110 may be a Busek BHT-350 thruster. Although a BHT-350 thruster 110 is shown in FIG. 1, it should be appreciated that other types of hall thrusters may be used in conjunction with hall thruster state monitoring system 100. Other examples include the OKB Fakel SPT-100 or NASA Advanced Electric Propulsion Systems (AEPS). Using the BHT-350 thruster, for example, this thruster may be fired in a facility giving access via antenna 105 to RF emissions. With antenna 105 placed inside of chamber 115, emissions emitting out chamber 115 may be characterized. In some embodiments, antenna 105 may be placed in the vicinity of, or near, thruster 110. Specifically, although placement of antenna 105 directly on thruster 110 is a possibility; in most cases, antenna 105 is placed near (or within the line of sight of) thruster 110. In these embodiments, the antenna is capacitively isolated from plasma either by separation or coating, and is tested up to 5 meters downstream from thruster exit plane. Further remote detection distances may be technically feasible.

As shown in FIG. 1, the emissions may be fed out of chamber 115 using radio frequency (RF) cabling 120. In some embodiments, an outer direct current (DC) block 135 may block DC signals from entering oscilloscope (or scope) 125 to provide scope protection. For example, a 4 GHz scope provides a bandwidth limitation, allowing any frequency below 4 GHz to be analyzed.

It should be appreciated that, with the 4 GHz bandwidth, the 20 GS/s sampling rate capability of oscilloscope 125 is not the only way to implement the proposed method/system. To clarify, the embodiment should include an oscilloscope 125 whose bandwidth is sufficiently high to resolve all frequencies of interest within the non-resonant response of antenna 105. If a person of ordinary skill in the art wishes to use the resonant portion of the antenna, this can work too, but it can a) limit the ability to interpret the amplitude of the received signals from one band to another, and b) limit dynamic range of measurement. The actual bandwidth used can be reduced, as needed, to improve the signal-to-noise ratio. Similarly, the sampling rate needs to be at least sufficient per the Nyquist sampling theorem. For example, during testing, success was found using 200 MHz bandwidth limited acquisitions in resolving the breathing mode, with 1 GS/sec for a total of 5 MS per trace.

In certain embodiments, the oscilloscope (or scope) 125 acts as a digitizer. The digitized data is then transmitted for further processing, or in some embodiments, may be processed locally on a separate computing system.

Antenna 105, in some embodiments, may be electrically short, which means that it is designed to pick up gigahertz level emissions while also detecting kilohertz emissions. In other words, even though the frequency transmission is out of the band being in kilohertz, antenna 105 is still able to pick up the emission. In short, the setup is a direct digitization of the signal voltage induced on antenna 105. It should be appreciated that using antenna 105 away from its designed resonant modes equates to a poor but flat signal response, which may be useful for performing relative amplitude linear time invariant digital signal processing (i.e., FFTs). However, the requirement is to have sufficient signal strength from the source and dynamic range for the receiver.

In certain embodiments, a feedthrough (e.g., N-type RF feedthrough) 130 may be placed on the wall of chamber 115. It should be noted that, although N-type feedthrough is discussed here, other RF feedthroughs may be used (e.g., SMA, N-type, 3.5 mm, etc.). In these embodiments, feedthrough 130 allows for the interfacing of the RF, which was received in a vacuum, to what's plum to air. Feedthrough 130 may be used on the ground and in the lab for testing purposes, in some embodiments. In certain embodiments, feedthrough 130 may be implemented as an isolated RF bulkhead. The isolated RF bulkhead may electrically isolate the ground of RF cable 120 from the metallic vacuum chamber, which is where antenna 105 resides. In this embodiment, a dedicated electrical grounding path is needed, and helps improve the signal fidelity in the ground testing environment.

However, when operating in space, neither the vacuum chamber nor the N-Type RF feedthrough would be required. Instead, in space environments, an RF cable 120 with DC block 135 connects directly to a RF front end digitizer. In some embodiments, the RF front end digitizer may be placed in front of the oscilloscope 125. In embodiments where oscilloscope 125 is not used, the RF front end digitizer transmits the data to either an onboard computing system or to a computing system on the ground. DC block 135 may act as a good protection mechanism for the digitizer or oscilloscope 125.

It should be noted that, depending on the embodiment, any high-speed sampling signal could be searched for relevant signals from the thruster (e.g., magnetometer). Further, any sensor that is sensitive to the breathing mode oscillation frequencies may also pick up the signal even if sampled at lower frequency, e.g., 1 Hz. In another embodiment, aside from direct digitization with antenna 105, filtering and a crystal diode detector or similar electronic detectors may be used to monitor the power of the breathing mode to reduce the quantity of data sampled.

In such embodiments, the detector or sensor is collecting the remote RF energy from the thruster and is diagnosing at least the breathing mode emissions from the thruster. Direct digitization of an antenna signal provides additional information.

In another embodiment, although not the primary application, the sensor may be repurposed as a monitor of the local electromagnetic environment around the antenna/spacecraft. This data may be convolved with thruster emissions when placed in the space environment

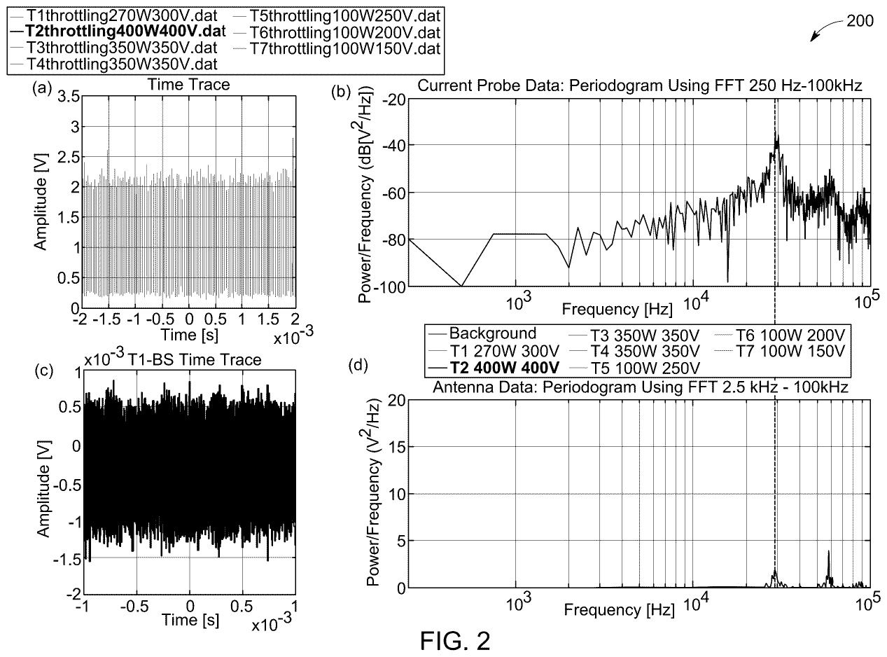

FIG. 2 is a graph 200 illustrating a thruster operating mode, according to an embodiment of the present invention. In graph 200, image (a) shows the time trace on the current probe. Image (b) shows a Fast Fourier Transform (FFT) of the current probe time trace, showing the peak on the frequency trace. In image (c), the time trace for the antenna diagnostic is shown, and in image (d), a corresponding FFT of the antenna diagnostic. The peak of the FFT in image (b) matches the peak in image (d). In short, these images (a)-(d) compare the current probe to the antenna probe, and their behavior for a particular operating mode, i.e., there are a separate set of images (a)-(d) for each operating mode.

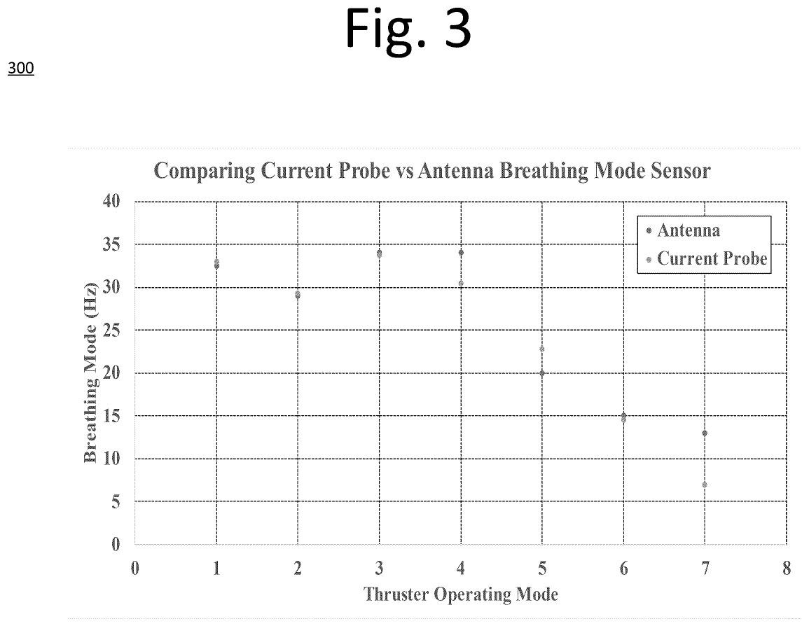

FIG. 3 is a chart 300 showing a summary comparison between the current probe and antenna breathing mode sensor for different operating modes deduced from plots like that which are shown in FIG. 2, according to an embodiment of the present invention. In some embodiments, chart 300 shows that the current probe measurements tracked with the antenna. For the very low power operating modes (e.g., 100 Watts), the ability to discern the breathing mode became a bit complicated in this example. This may result in additional interpretation of the data using human eye to discern the behavior of the thruster during the different operating modes. High fidelity breathing mode identification may be achieved triggering on the positive peak amplitude antenna emissions collected on the oscilloscope. In those embodiments, using a 200 MHz bandwidth limited oscilloscope collection over five 1 MS traces sampled at 1 GS/sec, a linear weighted average of the FFT of the five traces is performed to reduce random and non-stationary noise. A peak amplitude search to find the breathing mode frequency.

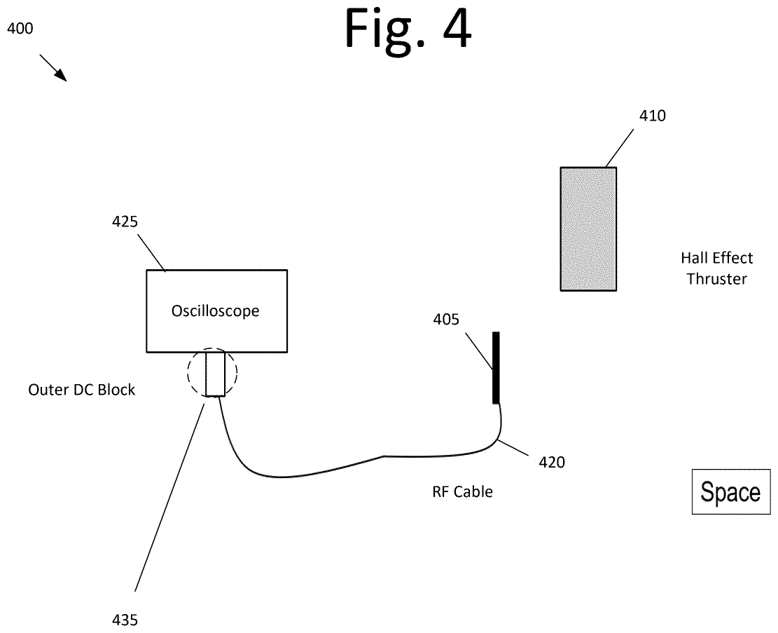

FIG. 4 is a diagram illustrating a hall thruster state monitoring system 400 using an omnidirectional antenna 405 in space, according to an embodiment of the present invention. In this embodiment, and similar to FIG. 1, antenna 405 is placed near thruster 410. A RF cable 420 may connect the data from antenna 405 to oscilloscope 425. Similar to FIG. 1, outer DC block 435 blocks DC signals from entering oscilloscope 425 in order to protect oscilloscope 425.

It should be appreciated that, in some embodiments, hall thruster state monitoring system 400 may include additional filters, low noise amplifiers, and/or signal conditioning (i.e., averaging) to improve signal-to-noise (SNR) ratio.

It should be appreciated that breathing mode may be found to exist in high power impulse magnetron sputtering (HiPIMS) devices. These devices are actively used in creating coatings for electrical and biomedical devices. The embodiments described herein may be readily adapted to industrial processing to monitor discharge noninvasively.

It should be appreciated that, aside from the breathing mode, the omnidirectional antenna has the potential to offer access to higher frequency noise than to which a current probe would be sensitive, since RE is occurring in the plume at higher frequencies than CE. This also means one can start to access the time correlated emissions across different bands in a way that was not previously accessible using current probes, alone. This could help in identifying out of family thruster performance. Importantly, CE relates to the power supply, whereas RE relates to the plasma. This diagnostic offers a means to correlate CE to RE to help in this identification process.

It will be readily understood that the components of various embodiments of the present invention, as generally described and illustrated in the figures herein, may be arranged and designed in a wide variety of different configurations. Thus, the detailed description of the embodiments of the systems, apparatuses, methods, and computer programs of the present invention, as represented in the attached figures, is not intended to limit the scope of the invention as claimed, but is merely representative of selected embodiments of the invention.

The features, structures, or characteristics of the invention described throughout this specification may be combined in any suitable manner in one or more embodiments. For example, reference throughout this specification to “certain embodiments,” “some embodiments,” or similar language means that a particular feature, structure, or characteristic described in connection with the embodiment is included in at least one embodiment of the present invention. Thus, appearances of the phrases “in certain embodiments,” “in some embodiment,” “in other embodiments,” or similar language throughout this specification do not necessarily all refer to the same group of embodiments and the described features, structures, or characteristics may be combined in any suitable manner in one or more embodiments.

It should be noted that reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

1. A hall thruster monitoring system, comprising:
an antenna configured to detect emissions from a thruster, the antenna being placed near or in the vicinity of a thruster; and
a radio frequency (RF) cable connecting the antenna with an oscilloscope or RF digitizer and a computer system to perform the analysis of thruster emissions.

2. The hall thruster monitoring system of claim 1, wherein the antenna is placed in the line of sight of the thruster.

3. The hall thruster monitoring system of claim 1, wherein the antenna is an omnidirectional antenna.

4. The hall thruster monitoring system of claim 1, wherein the oscilloscope is a 4 GHz oscilloscope with 20 GS/s providing a bandwidth limitation, facilitating analysis of any frequency less than 4 GHz.

5. The hall thruster monitoring system of claim 1, further comprising:
a direct current (DC) block configured to block DC signals in a signal voltage from entering the oscilloscope or RF digitizer to provide scope protection.

6. The hall thruster monitoring system of claim 1, wherein the oscilloscope or the RF digitizer is configured to transmit signal voltage received from the antenna to a computing system onboard a spacecraft or to a remote computing system.

7. The hall thruster monitoring system of claim 1, further comprising:
a n-type RF feedthrough placed on a wall of chamber, the n-type RF feedthrough configured to allow interfacing of the RF cable between the antenna and the oscilloscope or the RF digitizer.

8. The hall thruster monitoring system of claim 7, wherein the n-type RF feedthrough is an isolated RF bulkhead configured to electrically isolate a ground of the RF cable from a metallic vacuum chamber inside which the antenna 105 resides.

9. The hall thruster monitoring system of claim 1, wherein the antenna is capacitively isolated from plasma either by separation or coating.

10. A hall thruster monitoring system, comprising:
an antenna configured to detect emissions from a thruster, the antenna being placed near or in the vicinity of a thruster.
a radio frequency (RF) cable connecting the antenna with an oscilloscope or RF digitizer and a computer system to perform the analysis of thruster emissions, wherein
the antenna is placed in the line of sight of the thruster.

11. The hall thruster monitoring system of claim 10, wherein the antenna is an omnidirectional antenna.

12. The hall thruster monitoring system of claim 10, wherein the oscilloscope is a 4 GHz oscilloscope with 20 GS/s providing a bandwidth limitation, facilitating analysis of any frequency less than 4 GHz.

13. The hall thruster monitoring system of claim 10, further comprising:
a direct current (DC) block configured to block DC signals in a signal voltage from entering the oscilloscope or RF digitizer to provide scope protection.

14. The hall thruster monitoring system of claim 10, wherein the oscilloscope or the RF digitizer is configured to transmit signal voltage received from the antenna to a computing system onboard a spacecraft or to a remote computing system.

15. The hall thruster monitoring system of claim 10, further comprising:
a n-type RF feedthrough placed on a wall of chamber, the n-type RF feedthrough configured to allow interfacing of the RF cable between the antenna and the oscilloscope or the RF digitizer.

16. The hall thruster monitoring system of claim 15, wherein the n-type RF feedthrough is an isolated RF bulkhead configured to electrically isolate a ground of the RF cable from a metallic vacuum chamber inside which the antenna 105 resides.

17. The hall thruster monitoring system of claim 10, wherein the antenna is capacitively isolated from plasma either by separation or coating.

18. A hall thruster monitoring system, comprising:
an antenna configured to detect emissions from a thruster, the antenna being placed near or in the vicinity of a thruster;
a radio frequency (RF) cable connecting the antenna with an oscilloscope or RF digitizer and a computer system to perform the analysis of thruster emissions; and
a direct current (DC) block configured to block DC signals in a signal voltage from entering the oscilloscope or RF digitizer to provide scope protection, wherein the DC block is placed directly in front of the oscilloscope or the RF digitizer.

19. The hall thruster monitoring system of claim 18, wherein the oscilloscope is a 4 GHz oscilloscope with 20 GS/s providing a bandwidth limitation, facilitating analysis of any frequency less than 4 GHz.

20. The hall thruster monitoring system of claim 18, wherein the oscilloscope or the RF digitizer is configured to transmit signal voltage received from the antenna to a computing system onboard a spacecraft or to a remote computing system.
